(19) United States
(12) Patent Application Publication
(10) Pub. No.: US 2017/0215245 A1
(43) Pub. Date: Jul. 27, 2017

(54) LIGHT EMITTING DEVICE AND LIGHT EMISSION CONTROL METHOD THEREOF

(71) Applicant: Lextar Electronics Corporation, Hsinchu (TW)

(72) Inventors: Chien-Nan Yeh, Kaohsiung City (TW); Chun-Jong Chang, Zhubei City (TW); Po-Shen Chen, Hsinchu City (TW); Jhao-Cyuan Huang, New Taipei City (TW)

(21) Appl. No.: 15/362,203

(22) Filed: Nov. 28, 2016

(30) Foreign Application Priority Data
Jan. 22, 2016 (TW) 105102060

(51) Int. Cl. H05B 33/08

(52) U.S. Cl. CPC H05B 33/0845; H05B 33/0857; H05B 33/0809

(57) ABSTRACT

A light-emitting device includes a dimmer, a rectifier, a first light-emitting module, a first controller, a second light-emitting module and a second controller. The dimmer is coupled to an alternating current for modulating the alternating current into an alternating signal. The rectifier couples the dimmer to the alternating current for rectifying the alternating signal into a direct current signal. The first light-emitting module is for emitting a first light with a first color temperature. The first controller is coupled to the first light-emitting module for controlling the first light-emitting module to emit the first light. The second light-emitting module is for emitting a second light with a second color temperature different from the first color temperature. The second controller coupled to the second light-emitting module for controlling the second light-emitting module to emit the second light.

This application claims the benefit of Taiwan application Serial No. 105102060, filed Jan. 22, 2016, the subject matter of which is incorporated herein by reference.

### BACKGROUND OF THE INVENTION

Field of the Invention

The invention relates in general to a light emitting device and a light emission control method thereof, and more particularly to a light emitting device capable of controlling color temperature and a light emission control method thereof.

Description of the Related Art

Normally, the light emitted from the conventional light emitting device has one single color temperature only. However, the emission of the light with one single color temperature can only create one single scenario and can only be used in similar environments, hence limiting the application fields of the light emitting device.

Therefore, it has become a prominent task for the industries to provide a new light emitting device capable of expanding the application fields of the light emitting device.

### SUMMARY OF THE INVENTION

The invention is directed to a light emitting device and a light emission control method thereof capable of expanding the application fields of the light emitting device.

According to an embodiment of the present invention, a light emitting device is provided. The light emitting device includes a light modulator, a rectifier, a first light emitting module, a first controller, a second light emitting module and a second controller. The light modulator couples an alternating current (AC) and further modulates the alternating current to generate an alternating current dimming signal. The rectifier couples the light modulator and the alternating current and converts the alternating current dimming signal into a direct current dimming signal. The first light emitting module emits a first light with a first color temperature. The first controller couples the first light emitting module and is configured to control the first light emitting module to emit the first light, wherein the brightness of the first light varies with the change in the direct current dimming signal. The second light emitting module emits a second light with a second color temperature, wherein the first color temperature and the second color temperature are different. The second controller couples the second light emitting module and is configured to control the second light emitting module to emit the second light, wherein the brightness of the second light does not vary with the change in the direct current dimming signal.

According to another embodiment of the present invention, a light emission control method is provided. The light emission control method includes following steps. A light emitting device is provided, wherein the light emitting device includes a light modulator, a rectifier, a first light emitting module, a first controller, a second light emitting module and a second controller; the light modulator couples an alternating current and modulates the alternating current to generate an alternating current dimming signal; and the rectifier couples the light modulator and the alternating current and converts the alternating current dimming signal into a direct current dimming signal. The first light emitting module is controlled to emit a first light by the first controller, wherein the brightness of the first light varies with the change in the direct current dimming signal. The second light emitting module is controlled to emit a second light by the second controller, wherein the brightness of the second light does not vary with the change in the direct current dimming signal.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a functional block diagram of a light emitting device according to an embodiment of the invention.

FIG. 2 is a circuit diagram of he light emitting device of FIG. 1.

FIGS. 3A and 3B are relationship diagrams of the irradiating power of the first light emitting element and the dimming rate of the light modulator of FIG. 2.

FIGS. 4A and 4B are relationship diagrams of the irradiating power of the second light emitting element and the dimming rate of the light modulator of FIG. 2.

FIG. 5 is a functional block diagram of a light emitting device according to the invention another embodiment.

FIG. 6 is a circuit diagram of the light emitting device of FIG. 5.

FIG. 7A and 7B are relationship diagrams of the irradiating power of the first light emitting element and the dimming rate of the light modulator of FIG. 6.

FIG. 8A and 8B are relationship diagrams of the irradiating power of the second light emitting element and the dimming rate of the light modulator of FIG. 6.

### DETAILED DESCRIPTION OF THE INVENTION

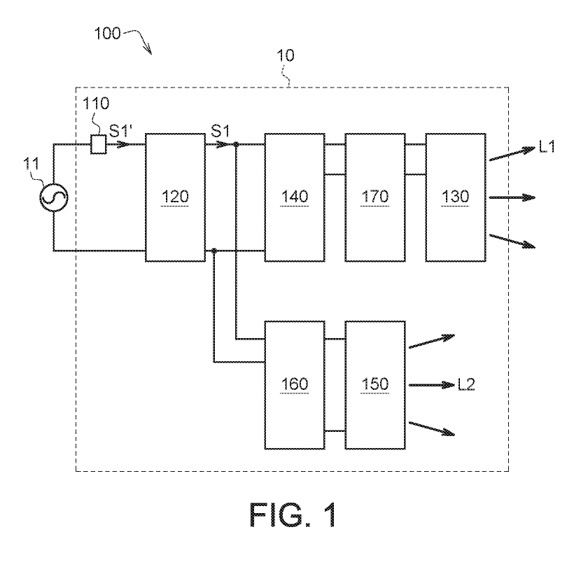

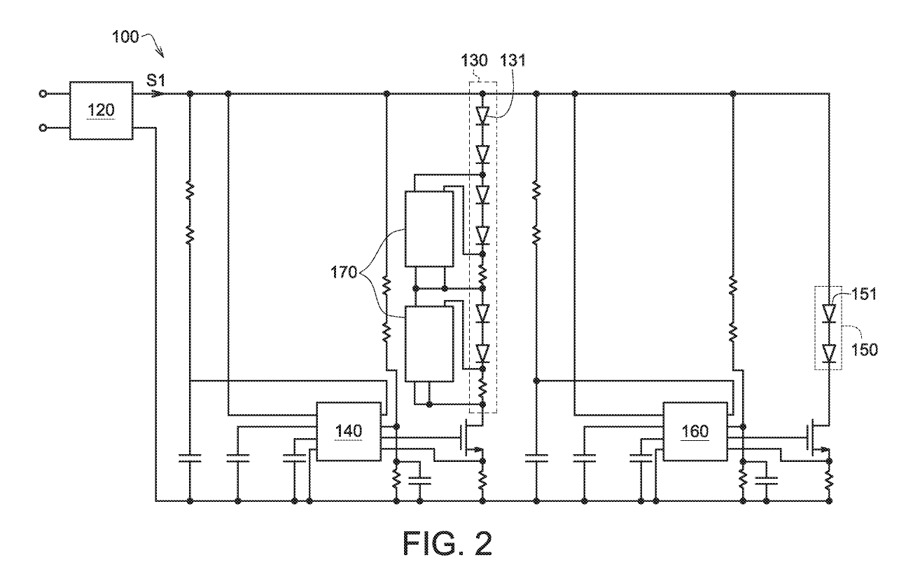

Refer to FIGS. 1 and 2. FIG. 1 is a functional block diagram of a light emitting device 100 according to an embodiment of the invention. FIG. 2 is a circuit diagram of the light emitting device 100 of FIG. 1.

The light emitting device 100 includes a light modulator 110, a rectifier 120, a first light emitting module 130, a first controller 140, a second light emitting module 150, a second controller 160 and a third controller 170. In an embodiment, the light modulator 110, the rectifier 120, the first light emitting module 130, the first controller 140, the second light emitting module 150, the second controller 160 and the third controller 170 can be integrated in a circuit board 10 to form a driver on board (DOB) structure, but the embodiment of the invention is not limited thereto. In another embodiment, at least one of the light modulator 110, the rectifier 120, the first light emitting module 130, the first controller 140, the second light emitting module 150, the second controller 160 and the third controller 170 can be integrated in the circuit board 10. For example, the first light emitting module 130, the first controller 140 and the third controller 170 can be integrated in the circuit board 10. Or, the second light emitting module 150 and the second controller 160 can be integrated in the circuit board 10.

The light modulator 110 couples the alternating current 11 and modulates the alternating current 11 to generate an alternating current dimming signal S1′. The rectifier 120 couples the light modulator 110 and the alternating current 11 and converts the alternating current dimming signal S1′ into a direct current dimming signal S1. The first light emitting module 130 emits a first light L1 with a first color temperature. The first controller 140 couples the first light emitting module 130 through the third controller 170 and controls the first light emitting module 130 to emit the first light L1, wherein the brightness of the first light L1 varies with the change in the direct current dimming signal. The second light emitting module 150 emits a second light L2 with a second color temperature. The first color temperature and the second color temperature are different. The second controller 160 couples the second light emitting module 150 and controls the second light emitting module 150 to emit a second light L2, wherein the brightness of the second light L2 does not vary with the change in the direct current dimming signal S1. Thus, the light emitting device 100 can emit lights with different color temperatures under different dimming rates. In an embodiment, the second color temperature is, for example, 2700 K, and the first color temperature is, for example, 3000 K.

As indicated in FIG. 2, the first light emitting module 130 includes a plurality of first light emitting elements 131 controlled by the third controller 170. The third controller 170 controls different quantities of first light emitting elements 131 to emit the first light L1 according to the change in the dimming rate of the light modulator 110. For example, the higher the dimming rate of the light modulator 110, the larger the quantity of first light emitting elements 131 can be controlled by the third controller 170 to emit the first light L1 and increase the brightness of the first light L1.

As indicated in FIG. 2, the second light emitting module 150 includes a plurality of second light emitting elements 151 controlled by the second controller 160 to emit the second light L2.

Additionally, the first light emitting element 131 and the second light emitting element 151 can be realized by light emitting diodes (LED). The color temperature of the first light L1 of the first light emitting element 131 can be higher than that of the second light L2 of the second light emitting element 151. In terms of quantity, the quantity of the first light emitting element 131 can be larger than the quantity of the second light emitting element 151. For example, the quantity of the first light emitting element 131 is 20, and the quantity of the second light emitting element 151 is 6, but the embodiment of the invention is not limited thereto.

The relationship between the irradiating power of the first light emitting element 131 and the irradiating power of the second light emitting element 151 and the dimming rate of the light modulator 110 is further exemplified below.

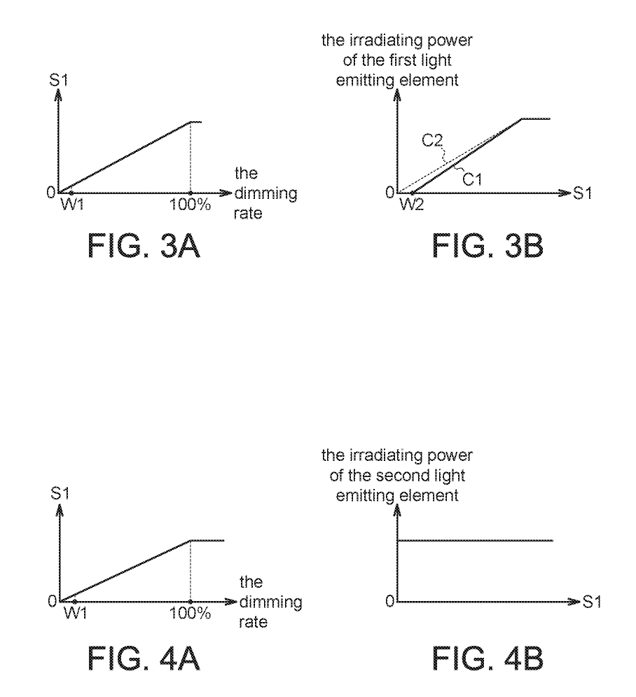

Referring to FIG. 3A and 3B, relationship diagrams of the irradiating power of the first light emitting element 131 and the dimming rate of the light modulator 110 of FIG. 2 are shown. As indicated in FIG. 3A, the magnitude of the direct current dimming signal S1 is proportional to the dimming rate of the light modulator 110. As indicated in FIG. 3A and 3B, the first predetermined value W2 of the curve C1 of FIG. 3B corresponds to the low dimming rate W1 of FIG. 3A. When the light modulator 110 is under the low dimming rate W1 (that is, the direct current dimming signal S1 is lower than the first predetermined value W2), such as under 10% or 50%, the irradiating power of the first light emitting element 131 is 0, and this implies that the first light emitting element 131 does not emit the first light L1. When the direct current dimming signal S1 is higher than the first predetermined value W2, the irradiating power of the first light emitting element 131 is larger than 0, and this implies that the first light emitting element 131 emits the first light L1. As indicated in FIG. 3B, the magnitude of the direct current dimming signal S1 is proportional to the irradiating power of the first light emitting element 131. That is, the larger the magnitude of the direct current dimming signal S1, the higher the emission luminance of the first light emitting element 131. Conversely, the smaller the magnitude of the direct current dimming signal S1, the lower the emission luminance of the first light emitting element 131.

Referring to FIG. 4A and 4B, relationship diagrams of the irradiating power of the second light emitting element 151 and the dimming rate of the light modulator 110 of FIG. 2 are shown. The irradiating power of the second light emitting element 151 does not vary with the change in the direct current dimming signal S1. To put it in greater details, as long as the direct current dimming signal S1 is larger than 0, the irradiating power of the second light emitting element 151 is larger than 0 and the irradiating power is fixed regardless what the magnitude of the direct current dimming signal S1 is.

In the present embodiment, the first color temperature of the first light L1 can be higher than the second color temperature of the second light L2. Thus, when the dimming rate is low, for example, when the direct current dimming signal S1 is lower than the first predetermined value W2, the light emitting device 100 can emit the second light L2 with low color temperature. When the direct current dimming signal S1 is equivalent to or higher than the first predetermined value W2, the light emitting device 100 can emit the second light L2 with low color temperature and the first light L1 with high color temperature at the same time. The irradiating power of the first light L1 with high color temperature is proportional to the magnitude of the direct current dimming signal S1.

As indicated in FIG. 3B, the first predetermined value W2 of the present embodiment is larger than 0. In another embodiment, the first predetermined value W2 is substantially equivalent to 0. Under such design, as indicated in the curve C2 of FIG. 3B, the first light emitting element 131 can emit the first light L1 with the first color temperature as long as the direct current dimming signal S1 is higher than 0. The irradiating power of the first light emitting element 131 is proportional to the magnitude of the direct current dimming signal S1.

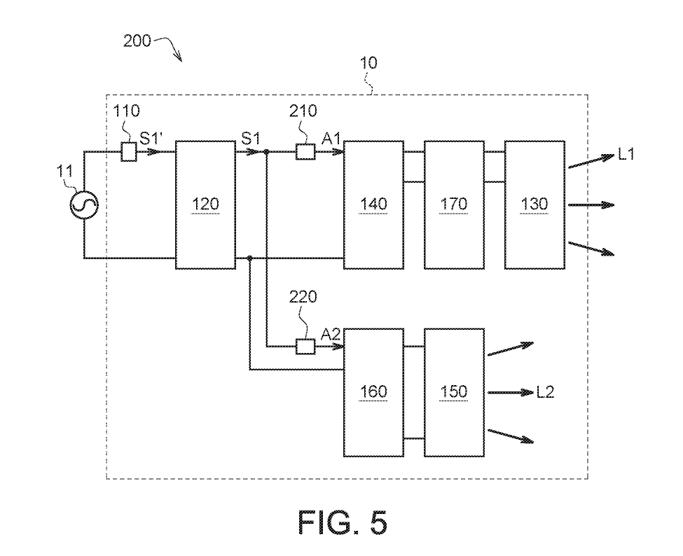

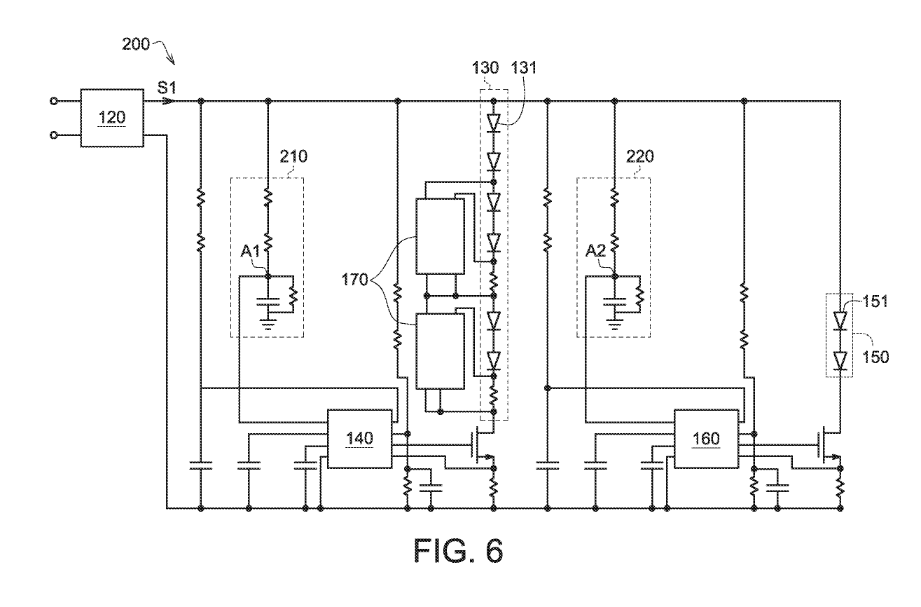

Refer to FIGS. 5 and 6. FIG. 5 is a functional block diagram of a light emitting device 200 according to the invention another embodiment. FIG. 6 is a circuit diagram of the light emitting device 200 of FIG. 5.

The light emitting device 200 includes a light modulator 110, a rectifier 120, a first light emitting module 130, a first controller 140, a second light emitting module 150, a second controller 160, a third controller 170, a first circuit 210 and a second circuit 220. In an embodiment, the light modulator 110, the rectifier 120, the first light emitting module 130, the first controller 140, the second light emitting module 150, the second controller 160, the third controller 170, the first circuit 210 and the second circuit 220 can be integrated in a circuit board 10 to form a DOB structure, but the embodiment of the invention is not limited thereto. In another embodiment, at least one of the light modulator 110, the rectifier 120, the first light emitting module 130, the first controller 140, the second light emitting module 150, the second controller 160, the third controller 170, the first circuit 210 and the second circuit 220 can be integrated in the circuit board 10. For example, the first light emitting module 130, the first controller 140, the third controller 170 and the first circuit 210 can be integrated in the circuit board 10. Or, the second light emitting module 150, the second controller 160 and the second circuit 220 can be integrated in the circuit board 10.

The first circuit 210 couples the rectifier 120 and the first controller 140. The first circuit 210 converts the direct current dimming signal S1 into a first voltage signal A1. The first controller 140 controls the first light emitting element 13 of the first light emitting module 130 to emit or not to emit the first light L1, and controls the first color temperature of the first light L1 according to the magnitude of the first voltage signal A1. In the present embodiment, the first circuit 210 is a resistor-capacitor circuit, such that the voltage of the converted first voltage signal A1 is smaller than that of the direct current dimming signal S1 and will not be too high to damage the controller.

The second circuit 220 couples the rectifier 120 and the second controller 160. The second circuit 220 converts the direct current dimming signal S1 into a second voltage signal A2. The second controller 160 can control the second light emitting element 151 of the second light emitting module 150 to emit or not to emit the second light L2. In the present embodiment, the second circuit 220 is a resistor-capacitor circuit, such that the voltage of the converted second voltage signal A2 is smaller than that of the direct current dimming signal S1 and will not be too high to damage the controller.

The relationship between the irradiating power of the first light emitting element 131 and the irradiating power of the second light emitting element 151 and the dimming rate of the light modulator 110 of FIG. 6 is exemplified below.

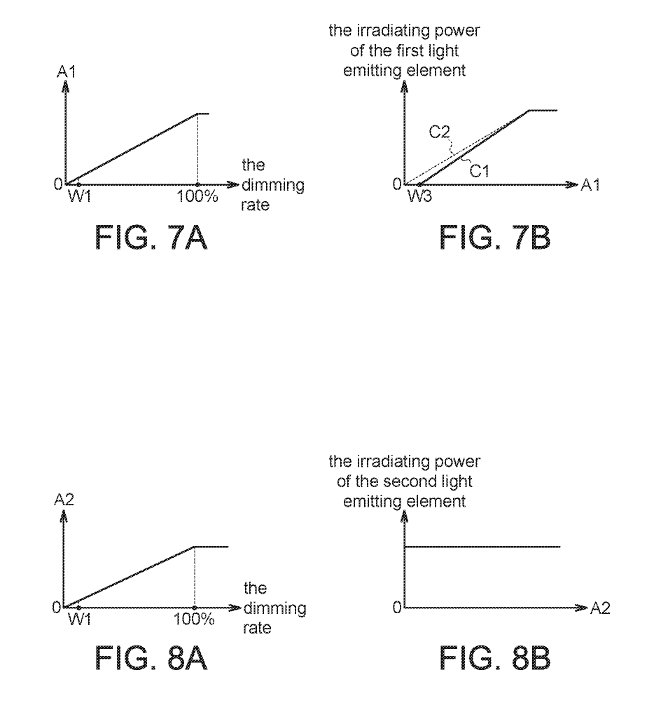

Referring to FIG. 7A and 7B, relationship diagrams of the irradiating power of the first light emitting element 131 and the dimming rate of the light modulator 110 FIG. 6 are shown. As indicated in FIG. 7A, the magnitude of the first voltage signal Al is proportional to the dimming rate of the light modulator 110. As indicated in FIGS. 7A and 7B, the second predetermined value W3 of the curve C1 of FIG. 7B corresponds to the low dimming rate W1 of FIG. 7A. When the light modulator 110 is under the low dimming rate W1 (that is, the first voltage signal A1 is lower than the second predetermined value W3), such as under 10% or 50%, the irradiating power of the first light emitting element 131 is 0, and this implies that the first light emitting element 131 does not emit the first light L1. When the first voltage signal A1 is higher than the second predetermined value W3, the irradiating power of the first light emitting element 131 is larger than 0, and this implies that the first light emitting element 131 emits the first light L1. As indicated in FIG. 7B, the magnitude of the first voltage signal A1 is proportional to the irradiating power of the first light emitting element 131. That is, the larger the first voltage signal A1 is, the higher the emission luminance of the first light emitting element 131 is. Conversely, the smaller the magnitude of the direct current dimming signal S1 is, the lower the emission luminance of the first light emitting element 131 is.

Referring to FIG. 8A and 8B, relationship diagrams of the irradiating power of the second light emitting element 151 and the dimming rate of the light modulator 110 of FIG. 6 are shown. The irradiating power of the second light emitting element 151 does not vary with the change in the second voltage signal A2. To put it in greater details, as long as the second voltage signal A2 is larger than 0, the irradiating power of the second light emitting element 151 is larger than 0 and the irradiating power is fixed regardless what the magnitude of the second voltage signal A2 is.

In the present embodiment, the first color temperature of the first light L1 is higher than the second color temperature of the second light L2. Thus, when the dimming rate is low, the light emitting device 100 still can emit the second light L2 with low color temperature as long as the second voltage signal A2 is higher than 0 although the first voltage signal A1 is lower than the second predetermined value W3. When the first voltage signal A1 is equivalent to or higher than the second predetermined value W3, the light emitting device 100 can emit the second light L2 with low color temperature and the first light L1 with high color temperature at the same time. The irradiating power of the first light L1 with high color temperature is proportional to the magnitude of the first voltage signal A1.

As indicated in FIG. 7B, the second predetermined value W3 of the present embodiment is larger than 0. In another embodiment, the second predetermined value W3 is substantially equivalent to 0. Under such design, as indicated in the curve C2 of FIG. 7B, the first light emitting element 131 can emit the first light L1 with the first color temperature as long as the first voltage signal A1 is higher than 0. The irradiating power of the first light emitting element 131 is proportional to the magnitude of the first voltage signal A1.

To summarize, the light emitting device of the embodiment of the invention can emit lights with different color temperatures according to different dimming rates, hence expanding the application fields of the light emitting device. To put it in greater details, the light emitting device of the embodiment of the invention can control the color temperature of the emitted light according to the environment. For example, when the dimming rate is low, the light emitting device can emit the light with a warmer color temperature. When the dimming rate is high, the light emitting device can emit the light with a colder color temperature. In an embodiment, the light emitting element of the light emitting device can be realized by light emitting diodes (LEDs), not only saving power but also providing different color temperatures to the emitted lights. In comparison to the conventional incandescent lamb, the light emitting device of the embodiment of the invention can save power consumption by at least 80% or 85%.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light emitting device, comprising:
a light modulator coupling an alternating current and modulating the alternating current to generate an alternating current dimming signal;
a rectifier coupling the light modulator and the alternating current and converting the alternating current dimming signal into a direct current dimming signal;
a first light emitting module emitting a first light with a first color temperature;
a first controller coupling the first light emitting module, wherein the first controller is configured to:
control the first light emitting module to emit the first light, wherein a brightness of the first light varies with the change in the direct current dimming signal;
a second light emitting module emitting a second light with a second color temperature, wherein the first color temperature and the second color temperature are different; and
a second controller coupling the second light emitting module, wherein the second controller is configured to:
control the second light emitting module to emit the second light, wherein a brightness of the second light does not vary with the change in the direct current dimming signal.

2. The light emitting device according to claim 1, wherein the first controller is configured to:
control the first light emitting module to emit the first light when the direct current dimming signal is higher than a first predetermined value; and
control the first light emitting module not to emit the light when the direct current dimming signal is lower than the first predetermined value.

3. The light emitting device according to claim 1, wherein the second controller is configured to:
control the second light emitting module to emit the second light when the direct current dimming signal is higher than 0.

4. The light emitting device according to claim 1, wherein the first color temperature is higher than the second color temperature.

5. The light emitting device according to claim 2, wherein the first predetermined value is equivalent to or larger than 0.

6. The light emitting device according to claim 1, further comprising:
a first circuit coupling the rectifier and the first controller and converting the direct current dimming signal into a first voltage signal, wherein the first controller is configured to:
control the first light emitting module to emit the first light when the first voltage signal is higher than a second predetermined value; and
control the first light emitting module not to emit the light when the first voltage signal is lower than the second predetermined value.

7. The light emitting device according to claim 6, wherein the second predetermined value is equivalent to or larger than 0.

8. The light emitting device according to claim 6, wherein the first circuit is a resistor-capacitor circuit.

9. The light emitting device according to claim 1, further comprising:
a second circuit coupling the rectifier and the second controller and converting the direct current dimming signal into a second voltage signal, wherein the second controller is configured to:
control the second light emitting module to emit the second light when the second voltage signal is higher than 0.

10. The light emitting device according to claim 9, wherein the second circuit is a resistor-capacitor circuit.

11. The light emitting device according to claim 1, further comprising:
a circuit board;
wherein the light modulator, the rectifier, the first light emitting module, the first controller, the second light emitting module and the second controller are integrated in the circuit board.

12. A light emission control method, comprising:
providing a light emitting device, wherein the light emitting device comprises a light modulator, a rectifier, a first light emitting module, a first controller, a second light emitting module and a second controller, the light modulator couples an alternating current and modulates the alternating current to generate an alternating current dimming signal, and the rectifier couples the light modulator and the alternating current and converts the alternating current dimming signal into a direct current dimming signal;
controlling the first light emitting module to emit a first light by the first controller, wherein a brightness of the first light varies with the change in the direct current dimming signal; and
controlling the second light emitting module to emit a second light by the second controller, wherein a brightness of the second light does not vary with the change in the direct current dimming signal.

13. The light emission control method according to claim 12, wherein the step of controlling the first light emitting module to emit the first light by the first controller comprises:
controlling the first light emitting module to emit the first light when the direct current dimming signal is higher than a first predetermined value; and
controlling the first light emitting module not to emit the light when the direct current dimming signal is lower than the first predetermined value.

14. The light emission control method according to claim 12, wherein the step of controlling the second light emitting module to emit the second light by the second controller comprises:
controlling the second light emitting module to emit the second light when the direct current dimming signal is higher than 0.

15. The light emission control method according to claim 12, wherein the first color temperature is higher than the second color temperature.

16. The light emission control method according to claim 13, wherein the first predetermined value is equivalent to or larger than 0.

17. The light emission control method according to claim 12, wherein the light emitting device further comprises a first circuit, and the light emission control method further comprises:
converting the direct current dimming signal into a first voltage signal by the first circuit;
controlling the first light emitting module to emit the first light by the first controller when the first voltage signal is higher than a second predetermined value; and
controlling the first light emitting module not to emit the light by the first controller when the first voltage signal is lower than the second predetermined value.

18. The light emission control method according to claim 17, wherein the second predetermined value is equivalent to or larger than 0.

19. The light emission control method according to claim 17, wherein the first circuit is a resistor-capacitor circuit.

20. The light emission control method according to claim 12, wherein the light emitting device further comprises a second circuit, and the light emission control method further comprises:
converting the direct current dimming signal into a second voltage signal by the second circuit; and
controlling the second light emitting module to emit the second light by the second controller when the second voltage signal is higher than 0.

21. The light emission control method according to claim 20, wherein the second circuit is a resistor-capacitor circuit.

22. The light emission control method according to claim 12, wherein the light emitting device further comprises a circuit board, a light modulator, a rectifier, a first light emitting module, and the first controller, the second light emitting module and the second controller are integrated in the circuit board.
